(19) United States
(12) Patent Application Publication
(10) Pub. No.: US 2024/0211016 A1
(43) Pub. Date: Jun. 27, 2024

(54) INTEGRATING AUTONOMOUS MEMORY SUBSYSTEM SELF-REFRESH WITH SYSTEM POWER MANAGEMENT STATES

(71) Applicant: Intel Corporation, Santa Clara, CA (US)

(72) Inventors: Vijay Anand MATHIYALAGAN, Austin, TX (US); Michelle M. WIGTON, Timnath, CO (US)

(21) Appl. No.: 18/598,810

(22) Filed: Mar. 7, 2024

(51) Int. Cl. G06F 1/3234; G06F 1/3228

(52) U.S. Cl. CPC G06F 1/3275; G06F 1/3228

(57) ABSTRACT

A system includes a resource controller that can determine if a memory has been idle for longer than a threshold. The resource controller is at the system level, above the memory subsystem. In response to determining the memory has been idle for at least the threshold, the resource controller can trigger the memory controller to send a shallow self-refresh command, which is self-refresh without clock stop.

### FIELD

Descriptions are generally related to computer systems, and more particular descriptions are related to device power management.

### BACKGROUND

Memory subsystem power consumption can be a significant portion of system power consumption. Memory self-refresh provides a low-power state for memory, has the penalty of long exit latency. There are also system low power states that place the memory into low power states.

The power manager that implements the system low-power states may require memory traffic to be idle for a long time (e.g., tens of milliseconds), due to the long exit latencies, the idle time may need to be long to justify the long exit latency. System low-power states are managed by the system power manager. Self-refresh is managed by the memory controller, and the system-level power states may need to override the self-refresh state. Potential conflicts of memory low power states with system low power states, as well as long exit latencies from low power states prevents the ability to significantly reduce memory power consumption.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1 is a block diagram of an example of a system with autonomous self refresh integrated with system power management.

FIG. 2 is a block diagram of an example of a system with a resource controller that manages autonomous self refresh.

FIG. 3 is a flow diagram of an example of a process for executing a shallow self refresh command.

FIG. 4 is a block diagram of an example of a memory subsystem in which shallow self refresh can be implemented.

FIGS. 5A-5B are block diagrams of an example of a CAMM system in which shallow self refresh can be implemented.

FIG. 6 is a block diagram of an example of a computing system in which shallow self refresh can be implemented.

FIG. 7 is a block diagram of an example of a multi-node network in which shallow self refresh can be implemented.

Descriptions of certain details and implementations follow, including non-limiting descriptions of the figures, which may depict some or all examples, and well as other potential implementations.

### DETAILED DESCRIPTION

As described herein, a system can integrate an SSR (shallow self-refresh) command to enable power savings modes with shorter exit latencies compared to system low power states. The SSR command is self-refresh without clock stop, where the memory subsystem is placed in self-refresh and the clock remains active. A self-refresh state for current DDR (double data rate) memories involves turning off the clock when the memory is in low power. SSR involves leaving the clock on when the memory is in low power. The expressions “shallow self-refresh,” SSR, self-refresh (SR) without clock stop, and SR without clock stop all refer herein to a memory being in a low power state and the data signaling clock still running.

Instead of having the memory controller make decisions regarding placing the memory into shallow self-refresh, a resource controller determines whether to place the memory into SSR and triggers the memory controller to implement the SSR. The resource controller is at the system level, above the memory subsystem. The resource controller can determine if the memory has been idle for longer than a threshold. In response to determining the memory has been idle for at least the threshold, the resource controller triggers the memory controller to send the SSR command.

As described herein, SSR provides a memory low power state that has an exit latency an order of magnitude shorter than package low power states. For example, SSR can have an exit latency on the order of 1 microsecond (us) as compared to a 20 us exit latency for self-refresh with a stopped clock or higher exit latencies for package low power states.

Where the system low power states (e.g., package C states) from system power management (PM) may not be justified unless the memory traffic is idle for a period on the order of tends of milliseconds (ms), SSR can be justified with memory idle on the order of tens of microseconds. With such relatively low idle times being able to utilize a memory low power state, the system described herein can provide significant memory power savings.

One class of memory subsystem that can apply the SSR state described is DDR (double data rate) DRAM (dynamic random access memory) devices, such as DDR5 (DDR version 5) or DDR6 (DDR version 6) that supports an SSR command or the equivalent. The DRAM devices can be implemented as a DIMM (dual inline memory module) or other multi-device package. An application of the use of SSR with a DDR5 system is estimated to provide power savings on the order of 10 Watts across 16 channels.

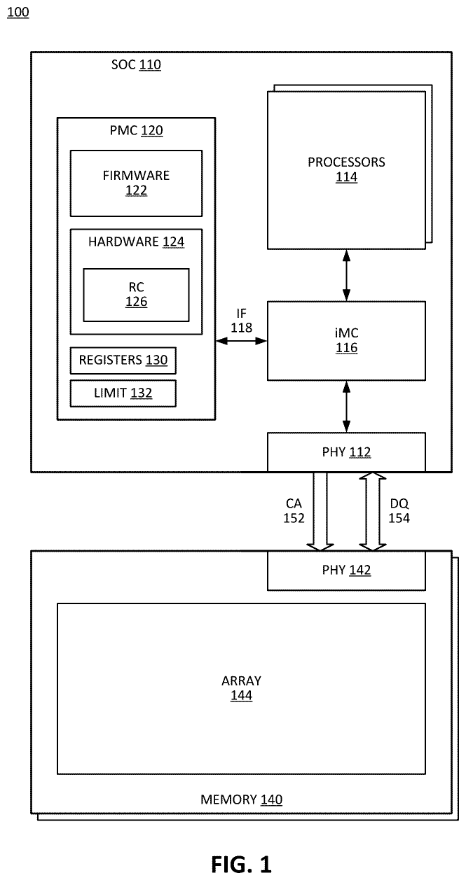

FIG. 1 is a block diagram of an example of a system with autonomous self refresh integrated with system power management. System 100 includes SOC (system on a chip) 110 with processors 114, iMC (integrated memory controller) 116, and PMC (power management controller) 120. SOC 110 can represent a hardware platform for system 100 (e.g., an SOC platform), including processing components, power management, and interface/peripheral management components.

Processors 114 represent processor elements that can generate requests for memory access. Processors 114 can include CPUs (central processing units), GPUs (graphics processing units), or other processor cores. iMC 116 would be integrated on the processor die of one or more of processors 114. In one example, the memory controller is not integrated with the processor die.

SOC 110 includes PHY (physical interface) 112. PHY 112 represents a physical interface between SOC 110 and memory 140. Memory 140 represents one or more memory dies/memory devices, which stores data in array 144. Array 144 represents the Memory 140 includes PHY 142 as physical interface circuitry to couple to SOC 110. The physical interface can include CA (command and address) 152, which represents a command and address bus and DQ (data) 154, which represents a data bus.

PMC 120 represents a system level power management component for system 100. PMC 120 manages power states for SOC 110. PMC 120 includes firmware 122 and hardware 124. Firmware 122 represents control logic implemented in code. Hardware 124 represents hardware logic for PMC 120. Firmware 122 can implement a state machine for power states. Hardware 124 includes RC (resource controller) 126. Resource controller 126 can include hardware to implement power state changes. Resource controller 126 be referred to as a resource controller circuitry, which is circuitry of hardware 124.

In one example, PMC 120 includes register 130. Register 130 can store information related to power states for system 100 and for SOC 110. In one example, PMC 120 includes limit 132, which represents a threshold or an idle time limit after which SSR can be triggered. Limit 132 can be a customer-defined value. In one example, limit 132 is a value in one of registers 130, and can thus represent a specific register that holds an idle threshold. The idle threshold can also be referred to as an inactivity threshold, referring to a period of time without memory access that can trigger SSR.

In one example, register 130 includes a hardware register to store a configuration to enable and disable autonomous actions for a power channel (P-channel) FSM (finite state machine). When the register bit is asserted, the autonomous actions can be enabled, and when deasserted, the P-channel can exit autonomous idle actions. In one example, register 130 includes a hardware register to store a time window for a filter for the P-channel, which can be limit 132.

The time window represents a consumer-specified threshold for the memory that will trigger a self-refresh without clock stop. The register can store the value as an amount of time or a number of clock cycles. Firmware 122 can dynamically enable and disable SSR through registers 130. In one example, firmware 122 can change the idle threshold. In one example, the timing settings such as thresholds can be exposed as CPU configuration knobs in boot time options.

System 100 provides platform power saving by targeting active idle and performance idle scenarios with a memory low power state with relatively short exit latency, making the low power state practical for scenarios with shorter idle periods. In one example, the SSR state has an exit latency that is orders of magnitude lower than Package C states. In one example, when the memory devices of memory 140 are placed in SSR, iMC 116 also places PHY 112 into a low power mode. Such operation can generate significant power savings without needing all SOC components to enter low idle power states.

To fully realize the potential of the SSR state, system 100 can integrate the application of SSR with system-level management. System-level management can refer to management of the processor components of SOC 110. The system-level management can refer to the integration of the SSR state with SOC power management states.

The integration of SSR into power management states can be accomplished by sharing control of the SSR state between PMC 120 and iMC 116. In one example, PMC 120 determines when to place memory 140 into SSR, and iMC 116 executes the SSR state.

Thus, instead of the memory controller making the autonomous decision to place memory 140 into SSR, PMC 120 can make the determination, and trigger iMC 116 to autonomously implement the SSR state. IMC 116 can continue to monitor access to memory and indicate to PMC 120 when traffic resumes. In response to such monitoring, PMC 120 can trigger iMC 116 to bring the memory subsystem back out of SSR.

SOC 110 has many PM (power management) states managed by PMC 120, some of which are not related to memory. System 100 can implement SSR autonomous to the memory subsystem, without being dependent on package PM states. Even though the implementation of SSR does not depend on the SOC PM states, having PMC 120 determine when to place memory in SSR can prevent SSR from colliding with other PM states.

In one example, SOC 110 manages the flow of SSR with standardized SOC interfaces, where the SOC firmware orchestrates the SSR operation. SSR is still autonomous to memory, and is not dependent on package states. SOC 110 can have many asynchronous functions, with power states that are asynchronous to the memory access activity levels. Thus, SOC 110 can have periods of memory inactivity that do align with some system-level power directives. With the integration of SSR into system-level power management decisions, system 100 can benefit from memory low power states that can be managed to coordinate with system power states.

SOC 110 includes IF (interface) 118 between iMC 116 and PMC 120. In one example, IF 118 is a standardized SOC interface, such as an AMBA (advanced microcontroller bus architecture) interface. In one example, IF 118 provides a system-level connection to manage SSR. In one example, IF 118 is a connection between iMC 116 and RC 126. In one example, system 100 implements an AMBA low power interface for iMC 116 to communicate with PMC 120, and implements a DFI (DDR PHY interface) interface for communication between memory subsystem components.

In one example, resource controller 126 manages the triggering of the SSR state. Thus, in one implementation, system 100 can manage SSR with PMC hardware. In one example, firmware 122 can implement a state machine to make decisions to trigger memory subsystem SSR states. In one example, PMC 120 can trigger SSR based on operation of firmware 122 in cooperation with resource controller 126.

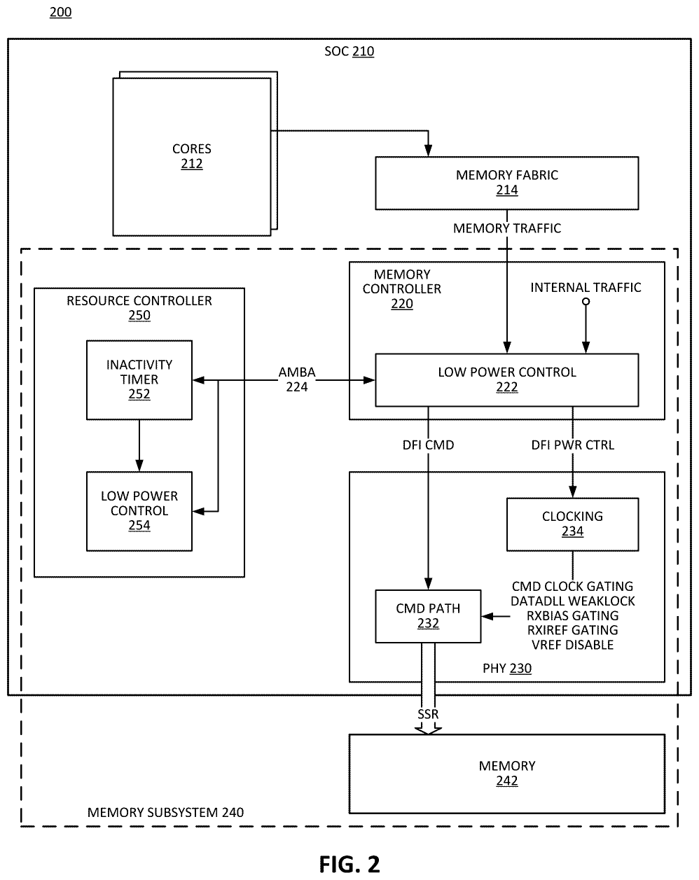

FIG. 2 is a block diagram of an example of a system with a resource controller that manages autonomous self refresh. System 200 illustrates a system in accordance with an example of system 100. System 200 represents SOC 210 coupled to memory 242. Memory 242 and components of SOC 210 represent the memory subsystem.

Cores 212 represent processor cores, which represent the processor elements for SOC 210. Cores 212 represent separate processing cores, which can include primary processor cores, graphics processor cores, accelerator cores, or other processing components that generate memory access requests. Cores 212 can send memory access requests to memory fabric 214, which represents the memory path between cores 212 and memory controller 220.

In one example, memory controller 220 is an integrated memory controller. Memory fabric 214 provides memory traffic to memory controller 220 for cores 212. Memory controller 220 can also generate internal traffic with memory access requests related to training and refresh.

Memory controller 220 provides commands and data to PHY 230, which represents the physical interface hardware to interconnect with memory 242. PHY 230 can include drivers, registers, buffers, and other components to allow the transfer of memory access commands and the transfer and receipt of data. CMD (command) path 232 represents the pathway for access commands to memory 242. DFI (DDR PHY interface) CMD represents the command transfer for the double data rate physical interface. The commands can include an SSR command as illustrated in system 200.

PHY 230 includes clocking 234, which represents circuitry in the PHY to control the timing of command and data signaling. Clocking control can include, among other control: CMD (command) clock gating, dataDLL (delay-locked loop for the data path) weaklock, RXBias (receive bias) gating, VREF (reference voltage) disable. The clocking control can manage the timing of the data path (not specifically illustrated) and CMD path 232. In one example, memory controller 220 manages clock 234 with DFI PWR (power) CTRL (control). The DFI power control represents signaling by memory controller 220 to change the timing of data or commands or both.

Memory subsystem 240 includes memory 242, PHY 230, and memory controller 220. In one example, the SOC PMC can include a resource controller circuit that is part of memory subsystem 240. Resource controller 250 represents a resource controller circuit that manages SSR states in one implementation of system 200. In another implementation, the PMC firmware is fully involved or at least partially involved in making the decision for memory subsystem 240 to enter an SSR state.

In one example, memory controller 220 includes low power control 222. Low power control 222 represents circuitry or firmware logic or a combination of the two. Low power control 222 can at least partially manage the DFI command and the DFI power control, triggering low power states due to inactivity.

In one example, resource controller 250 includes inactivity timer 252 and low power control 254. Inactivity timer 252 represents a timer that can determine a length of time memory access is idle in SOC 210. Inactivity timer 252 can alternatively be referred to as an idle timer. Low power control 254 represents logic in resource controller 250 to receive information from memory controller 220 and to trigger memory controller 220 to execute SSR.

In one example, memory controller 220 and resource controller 250 are coupled via AMBA 224, which represents an AMBA interface in SOC 210. AMBA 224 enables memory controller 220 to provide activity information to resource controller 250. AMBA 224 can enable memory controller 220 to send memory subsystem inactivity information and enable resource controller 250 to initiate entering the low power state. In one example, the SSR state includes placing memory 242 in self-refresh without clock stop and placing PHY 230 into a low power state.

In one example, AMBA 224 serializes package PM states managed by the firmware of the PMC (not specifically illustrated). The PMC can alternatively be referred to as a P-unit. connections to the PMC can also be referred to as P-channels, referring to power channels for power management.

System 200 can implement memory subsystem autonomous power savings as follows. Memory controller 220, through low power control 222, can monitor memory traffic from memory fabric 214, as well as the internally generated commands. Idleness is when no activity is present in memory controller 220.

Memory controller 220, through low power control 222, can indicate idleness to resource controller 250 through a P-channel of AMBA 224. Resource controller 250 can monitor indications from memory controller 220 about memory access traffic to determine idleness, and when memory traffic starts again after a period of idleness.

In one example, resource controller 250 initiates inactivity timer 252. Inactivity timer 252 can be a hysteresis idleness timer that tracks a length of time memory access has been idle. In one example, the firmware of the PMC can dynamically change the hysteresis timer value. Where an indication from memory controller 220 that it is idle can cause resource controller 250 to start inactivity timer 252, when memory controller 220 detects traffic, it can then report that new traffic to resource controller 250. In one example, in response to detection of traffic, resource controller 250 will stop and reset inactivity timer 252.

If inactivity timer 252 reaches a configured idleness timer threshold before memory controller 220 indicates new memory traffic, low power control 254 of resource controller 250 can direct low power control 222 of memory controller 220 through AMBA 224 to enter shallow self refresh.

In one example, even if the threshold is reached, resource controller 250 may not trigger memory controller 220 to initiate SSR if the SSR state would conflict with other system-level power states. Thus, the SSR operation can be integrated to operate independently of system-level power states except when such operation would conflict with system-level directives.

In one example, memory controller 220 sends an SSR command to memory (e.g., installed DIMMs) over CMD path 232. Additionally, memory controller 220 can put PHY 230 into a low power mode through DFI power control, triggering low power to the controls of the physical interface. With memory 242 in SSR and PHY 230 in low power, memory subsystem 240 is in a shallow self refresh state.

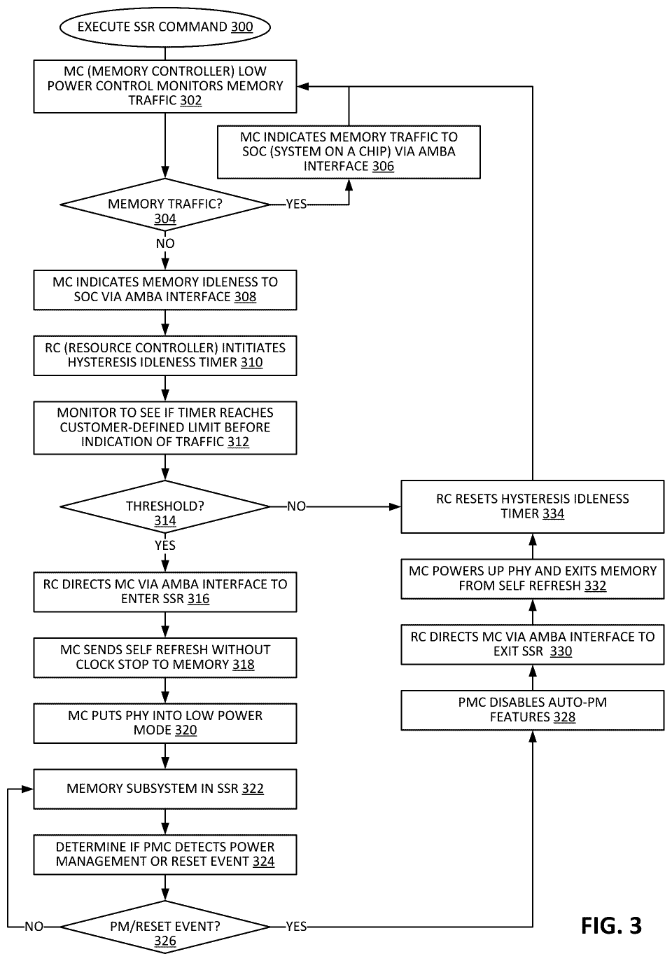

FIG. 3 is a flow diagram of an example of a process for executing a shallow self refresh command. Process 300 represents a process for executing a shallow self refresh command in accordance with an example of system 100 or system 200.

MC (memory controller) low power control monitors the memory traffic in the SOC, at 302. If no entity in the SOC needs to access the memory, there will not be any memory traffic. If there is memory traffic, at 304 YES branch, in one example, the memory controller indicates the memory traffic to the PMC of the SOC via an AMBA interface, at 306. In one example, the memory controller can indicate traffic through another system-level interface other than an AMBA interface. When there is memory traffic, the system can continue to monitor for an idle condition.

If there is no memory traffic, at 304 NO branch, the memory is idle. The memory controller can indicate memory idleness to the SOC via the AMBA interface or other interface, at 308. In one example, an RC (resource controller) of the SOC PMC can initiate a hysteresis idleness timer in response to the indication of memory idleness, at 310. The resource controller can monitor to see if the timer reaches a customer-defined limit before the memory controller provides another indication of memory traffic, at 312. In one example, the hysteresis idleness timer is dynamically configurable by the PMC, indicating how long a period of idleness will trigger an SSR state for the memory subsystem.

If the memory controller indicates traffic before the timer reaches the threshold, at 314 NO branch, in one example, the resource controller resets the hysteresis idleness timer, at 334, and the system can again wait for the memory controller to monitor for traffic idleness, starting at 302.

If the timer reaches the threshold, at 314 YES branch, the resource controller can direct the memory controller via the AMBA interface to enter SSR, at 316. Process 300 thus illustrates one example of hardware management of the SSR state that is dependent only on memory traffic, and does not directly depend on the processing cores and their states. In response to the message by the resource controller, the memory controller can send a self-refresh without clock stop to the memory, at 318. In one example, the memory controller also places the PHY into a low power mode, at 320.

With the memory subsystem in SSR, at 322, the system can monitor to determine if the PMC detects a power management event or a memory traffic reset event, at 324. The power management event refers to an event/condition at the SOC-level power management that indicates a change in power management state for the SOC. A memory traffic reset event refers to detection of memory traffic by the memory controller and reported to the resource controller.

As long as there is no event to change power state, at 326 NO branch, the memory subsystem can remain in SSR, at 322. If there is an event to change the power state, at 326 YES branch, in one example, the PMC disables the autonomous power management features of the memory subsystem, at 328. Thus, the SSR state becomes a state that is no longer valid for the memory subsystem. The system then performs “unwind” operations to remove the memory subsystem from SSR to prepare to transition into the SOC power state.

The resource controller can direct the memory controller to via the AMBA interface to exit SSR, at 330. The memory controller power up the PHY and exits the memory from self-refresh, at 332. The resource controller can reset the hysteresis idleness timer, at 324, and the system can return to the memory controller monitoring for idleness. The system may instead enter a different SOC power state.

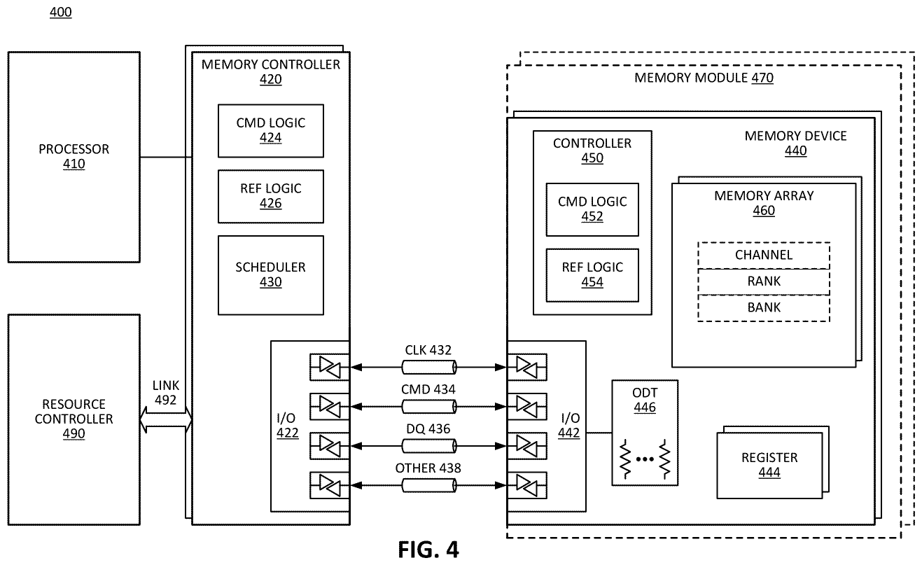

FIG. 4 is a block diagram of an example of a memory subsystem in which shallow self refresh can be implemented. System 400 includes a processor and elements of a memory subsystem in a computing device.

System 400 is an example of a system in accordance with an example of system 100 or an example of system 200. In one example, system 400 includes resource controller 490, which represents a circuit of a power management controller in accordance with any example herein. Resource controller 490 can connect with memory controller 420 via link 492, allowing memory controller 420 to provide memory access idleness information to the PMC, and enabling the PMC to trigger memory controller 420 to issue a low power state without clock stop, in accordance with any description herein.

Processor 410 represents a processing unit of a computing platform that may execute an operating system (OS) and applications, which can collectively be referred to as the host or the user of the memory. The OS and applications execute operations that result in memory accesses. Processor 410 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory accesses may also be initiated by devices such as a network controller or hard disk controller. Such devices can be integrated with the processor in some systems or attached to the processer via a bus (e.g., PCI express), or a combination. System 400 can be implemented as an SOC (system on a chip), or be implemented with standalone components.

Reference to memory devices can apply to different memory types. Memory devices often refers to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random-access memory), or some variant such as synchronous DRAM (SDRAM). A memory subsystem as described herein may be compatible with a number of memory technologies, such as DDR4 (double data rate version 4, JESD79-4, originally published in September 2012 by JEDEC (Joint Electron Device Engineering Council, now the JEDEC Solid State Technology Association), LPDDR4 (low power DDR version 4, JESD209-4, originally published by JEDEC in August 2014), WIO2 (Wide I/O 2 (WideIO2), JESD229-2, originally published by JEDEC in August 2014), HBM (high bandwidth memory DRAM, JESD235A, originally published by JEDEC in November 2015), DDR5 (DDR version 5, originally published by JEDEC in July 2020), LPDDR5 (LPDDR version 5, JESD209-5, originally published by JEDEC in February 2019), HBM2 (HBM version 2, JESD235C, originally published by JEDEC in January 2020), HBM3 (HBM version 3, JESD238, originally published by JEDEC in January 2022), DDR6 (DDR version 6, currently in discussion by JEDEC), or others or combinations of memory technologies, and technologies based on derivatives or extensions of such specifications.

Memory controller 420 represents one or more memory controller circuits or devices for system 400. Memory controller 420 represents control logic that generates memory access commands in response to the execution of operations by processor 410. Memory controller 420 accesses one or more memory devices 440. Memory devices 440 can be DRAM devices in accordance with any referred to above. In one example, memory devices 440 are organized and managed as different channels, where each channel couples to buses and signal lines that couple to multiple memory devices in parallel. Each channel is independently operable. Thus, each channel is independently accessed and controlled, and the timing, data transfer, command and address exchanges, and other operations are separate for each channel. Coupling can refer to an electrical coupling, communicative coupling, physical coupling, or a combination of these. Physical coupling can include direct contact. Electrical coupling includes an interface or interconnection that allows electrical flow between components, or allows signaling between components, or both. Communicative coupling includes connections, including wired or wireless, that enable components to exchange data.

In one example, settings for each channel are controlled by separate mode registers or other register settings. In one example, each memory controller 420 manages a separate memory channel, although system 400 can be configured to have multiple channels managed by a single controller, or to have multiple controllers on a single channel. In one example, memory controller 420 is part of host processor 410, such as logic implemented on the same die or implemented in the same package space as the processor.

Memory controller 420 includes I/O interface logic 422 to couple to a memory bus, such as a memory channel as referred to above. I/O interface logic 422 (as well as I/O interface logic 442 of memory device 440) can include pins, pads, connectors, signal lines, traces, or wires, or other hardware to connect the devices, or a combination of these. I/O interface logic 422 can include a hardware interface. As illustrated, I/O interface logic 422 includes at least drivers/transceivers for signal lines. Commonly, wires within an integrated circuit interface couple with a pad, pin, or connector to interface signal lines or traces or other wires between devices. I/O interface logic 422 can include drivers, receivers, transceivers, or termination, or other circuitry or combinations of circuitry to exchange signals on the signal lines between the devices. The exchange of signals includes at least one of transmit or receive. While shown as coupling I/O 422 from memory controller 420 to I/O 442 of memory device 440, it will be understood that in an implementation of system 400 where groups of memory devices 440 are accessed in parallel, multiple memory devices can include I/O interfaces to the same interface of memory controller 420. In an implementation of system 400 including one or more memory modules 470, I/O 442 can include interface hardware of the memory module in addition to interface hardware on the memory device itself. Other memory controllers 420 will include separate interfaces to other memory devices 440.

The bus between memory controller 420 and memory devices 440 can be implemented as multiple signal lines coupling memory controller 420 to memory devices 440. The bus may typically include at least clock (CLK) 432, command/address (CMD) 434, and write data (DQ) and read data (DQ) 436, and zero or more other signal lines 438. In one example, a bus or connection between memory controller 420 and memory can be referred to as a memory bus. In one example, the memory bus is a multi-drop bus. The signal lines for CMD can be referred to as a “C/A bus” (or ADD/CMD bus, or some other designation indicating the transfer of commands (C or CMD) and address (A or ADD) information) and the signal lines for write and read DQ can be referred to as a “data bus.” In one example, independent channels have different clock signals, C/A buses, data buses, and other signal lines. Thus, system 400 can be considered to have multiple “buses,” in the sense that an independent interface path can be considered a separate bus. It will be understood that in addition to the lines explicitly shown, a bus can include at least one of strobe signaling lines, alert lines, auxiliary lines, or other signal lines, or a combination. It will also be understood that serial bus technologies can be used for the connection between memory controller 420 and memory devices 440. An example of a serial bus technology is 8B10B encoding and transmission of high-speed data with embedded clock over a single differential pair of signals in each direction. In one example, CMD 434 represents signal lines shared in parallel with multiple memory devices. In one example, multiple memory devices share encoding command signal lines of CMD 434, and each has a separate chip select (CS_n) signal line to select individual memory devices.

It will be understood that in the example of system 400, the bus between memory controller 420 and memory devices 440 includes a subsidiary command bus CMD 434 and a subsidiary bus to carry the write and read data, DQ 436. In one example, the data bus can include bidirectional lines for read data and for write/command data. In another example, the subsidiary bus DQ 436 can include unidirectional write signal lines for write and data from the host to memory, and can include unidirectional lines for read data from the memory to the host. In accordance with the chosen memory technology and system design, other signals 438 may accompany a bus or sub bus, such as strobe lines DQS. Based on design of system 400, or implementation if a design supports multiple implementations, the data bus can have more or less bandwidth per memory device 440. For example, the data bus can support memory devices that have either a ×4 interface, a ×8 interface, a ×16 interface, or other interface. The convention “xW,” where W is an integer that refers to an interface size or width of the interface of memory device 440, which represents a number of signal lines to exchange data with memory controller 420. The interface size of the memory devices is a controlling factor on how many memory devices can be used concurrently per channel in system 400 or coupled in parallel to the same signal lines. In one example, high bandwidth memory devices, wide interface devices, or stacked memory configurations, or combinations, can enable wider interfaces, such as a ×128 interface, a ×256 interface, a ×512 interface, a ×1024 interface, or other data bus interface width.

In one example, memory devices 440 and memory controller 420 exchange data over the data bus in a burst, or a sequence of consecutive data transfers. The burst corresponds to a number of transfer cycles, which is related to a bus frequency. In one example, the transfer cycle can be a whole clock cycle for transfers occurring on a same clock or strobe signal edge (e.g., on the rising edge). In one example, every clock cycle, referring to a cycle of the system clock, is separated into multiple unit intervals (UIs), where each UI is a transfer cycle. For example, double data rate transfers trigger on both edges of the clock signal (e.g., rising and falling). A burst can last for a configured number of UIs, which can be a configuration stored in a register, or triggered on the fly. For example, a sequence of eight consecutive transfer periods can be considered a burst length eight (BL8), and each memory device 440 can transfer data on each UI. Thus, a ×8 memory device operating on BL8 can transfer 64 bits of data (8 data signal lines times 8 data bits transferred per line over the burst). It will be understood that this simple example is merely an illustration and is not limiting.

Memory devices 440 represent memory resources for system 400. In one example, each memory device 440 is a separate memory die. In one example, each memory device 440 can interface with multiple (e.g., 2) channels per device or die. Each memory device 440 includes I/O interface logic 442, which has a bandwidth determined by the implementation of the device (e.g., ×16 or ×8 or some other interface bandwidth). I/O interface logic 442 enables the memory devices to interface with memory controller 420. I/O interface logic 442 can include a hardware interface, and can be in accordance with I/O 422 of memory controller, but at the memory device end. In one example, multiple memory devices 440 are connected in parallel to the same command and data buses. In another example, multiple memory devices 440 are connected in parallel to the same command bus, and are connected to different data buses. For example, system 400 can be configured with multiple memory devices 440 coupled in parallel, with each memory device responding to a command, and accessing memory resources 460 internal to each. For a Write operation, an individual memory device 440 can write a portion of the overall data word, and for a Read operation, an individual memory device 440 can fetch a portion of the overall data word. The remaining bits of the word will be provided or received by other memory devices in parallel.

In one example, memory devices 440 are disposed directly on a motherboard or host system platform (e.g., a PCB (printed circuit board) or substrate on which processor 410 is disposed) of a computing device. In one example, memory devices 440 can be organized into memory modules 470. In one example, memory modules 470 represent dual inline memory modules (DIMMs). In one example, memory modules 470 represent other organization of multiple memory devices to share at least a portion of access or control circuitry, which can be a separate circuit, a separate device, or a separate board from the host system platform. Memory modules 470 can include multiple memory devices 440, and the memory modules can include support for multiple separate channels to the included memory devices disposed on them. In another example, memory devices 440 may be incorporated into the same package as memory controller 420, such as by techniques such as multi-chip-module (MCM), package-on-package, through-silicon via (TSV), or other techniques or combinations. Similarly, in one example, multiple memory devices 440 may be incorporated into memory modules 470, which themselves may be incorporated into the same package as memory controller 420. It will be appreciated that for these and other implementations, memory controller 420 may be part of host processor 410.

Memory devices 440 each include one or more memory arrays 460. Memory array 460 represents addressable memory locations or storage locations for data. Typically, memory array 460 is managed as rows of data, accessed via wordline (rows) and bitline (individual bits within a row) control. Memory array 460 can be organized as separate channels, ranks, and banks of memory. Channels may refer to independent control paths to storage locations within memory devices 440. Ranks may refer to common locations across multiple memory devices (e.g., same row addresses within different devices) in parallel. Banks may refer to sub-arrays of memory locations within a memory device 440. In one example, banks of memory are divided into sub-banks with at least a portion of shared circuitry (e.g., drivers, signal lines, control logic) for the sub-banks, allowing separate addressing and access. It will be understood that channels, ranks, banks, sub-banks, bank groups, or other organizations of the memory locations, and combinations of the organizations, can overlap in their application to physical resources. For example, the same physical memory locations can be accessed over a specific channel as a specific bank, which can also belong to a rank. Thus, the organization of memory resources will be understood in an inclusive, rather than exclusive, manner.

In one example, memory devices 440 include one or more registers 444. Register 444 represents one or more storage devices or storage locations that provide configuration or settings for the operation of the memory device. In one example, register 444 can provide a storage location for memory device 440 to store data for access by memory controller 420 as part of a control or management operation. In one example, register 444 includes one or more Mode Registers. In one example, register 444 includes one or more multipurpose registers. The configuration of locations within register 444 can configure memory device 440 to operate in different “modes,” where command information can trigger different operations within memory device 440 based on the mode. Additionally or in the alternative, different modes can also trigger different operation from address information or other signal lines depending on the mode. Settings of register 444 can indicate configuration for I/O settings (e.g., timing, termination or ODT (on-die termination) 446, driver configuration, or other I/O settings).

In one example, memory device 440 includes ODT 446 as part of the interface hardware associated with I/O 442. ODT 446 can be configured as mentioned above, and provide settings for impedance to be applied to the interface to specified signal lines. In one example, ODT 446 is applied to DQ signal lines. In one example, ODT 446 is applied to command signal lines. In one example, ODT 446 is applied to address signal lines. In one example, ODT 446 can be applied to any combination of the preceding. The ODT settings can be changed based on whether a memory device is a selected target of an access operation or a non-target device. ODT 446 settings can affect the timing and reflections of signaling on the terminated lines. Careful control over ODT 446 can enable higher-speed operation with improved matching of applied impedance and loading. ODT 446 can be applied to specific signal lines of I/O interface 442, 422 (for example, ODT for DQ lines or ODT for CA lines), and is not necessarily applied to all signal lines.

Memory device 440 includes controller 450, which represents control logic within the memory device to control internal operations within the memory device. For example, controller 450 decodes commands sent by memory controller 420 and generates internal operations to execute or satisfy the commands. Controller 450 can be referred to as an internal controller, and is separate from memory controller 420 of the host. Controller 450 can determine what mode is selected based on register 444, and configure the internal execution of operations for access to memory resources 460 or other operations based on the selected mode. Controller 450 generates control signals to control the routing of bits within memory device 440 to provide a proper interface for the selected mode and direct a command to the proper memory locations or addresses. Controller 450 includes command logic 452, which can decode command encoding received on command and address signal lines. Thus, command logic 452 can be or include a command decoder. With command logic 452, memory device can identify commands and generate internal operations to execute requested commands.

Referring again to memory controller 420, memory controller 420 includes command (CMD) logic 424, which represents logic or circuitry to generate commands to send to memory devices 440. The generation of the commands can refer to the command prior to scheduling, or the preparation of queued commands ready to be sent. Generally, the signaling in memory subsystems includes address information within or accompanying the command to indicate or select one or more memory locations where the memory devices should execute the command. In response to scheduling of transactions for memory device 440, memory controller 420 can issue commands via I/O 422 to cause memory device 440 to execute the commands. In one example, controller 450 of memory device 440 receives and decodes command and address information received via I/O 442 from memory controller 420. Based on the received command and address information, controller 450 can control the timing of operations of the logic and circuitry within memory device 440 to execute the commands. Controller 450 is responsible for compliance with standards or specifications within memory device 440, such as timing and signaling requirements. Memory controller 420 can implement compliance with standards or specifications by access scheduling and control.

Memory controller 420 includes scheduler 430, which represents logic or circuitry to generate and order transactions to send to memory device 440. From one perspective, the primary function of memory controller 420 could be said to schedule memory access and other transactions to memory device 440. Such scheduling can include generating the transactions themselves to implement the requests for data by processor 410 and to maintain integrity of the data (e.g., such as with commands related to refresh). Transactions can include one or more commands, and result in the transfer of commands or data or both over one or multiple timing cycles such as clock cycles or unit intervals. Transactions can be for access such as read or write or related commands or a combination, and other transactions can include memory management commands for configuration, settings, data integrity, or other commands or a combination.

Memory controller 420 typically includes logic such as scheduler 430 to allow selection and ordering of transactions to improve performance of system 400. Thus, memory controller 420 can select which of the outstanding transactions should be sent to memory device 440 in which order, which is typically achieved with logic much more complex that a simple first-in first-out algorithm. Memory controller 420 manages the transmission of the transactions to memory device 440, and manages the timing associated with the transaction. In one example, transactions have deterministic timing, which can be managed by memory controller 420 and used in determining how to schedule the transactions with scheduler 430.

In one example, memory controller 420 includes refresh (REF) logic 426. Refresh logic 426 can be used for memory resources that are volatile and need to be refreshed to retain a deterministic state. In one example, refresh logic 426 indicates a location for refresh, and a type of refresh to perform. Refresh logic 426 can trigger self-refresh within memory device 440, or execute external refreshes which can be referred to as auto refresh commands) by sending refresh commands, or a combination. In one example, controller 450 within memory device 440 includes refresh logic 454 to apply refresh within memory device 440. In one example, refresh logic 454 generates internal operations to perform refresh in accordance with an external refresh received from memory controller 420. Refresh logic 454 can determine if a refresh is directed to memory device 440, and what memory resources 460 to refresh in response to the command.

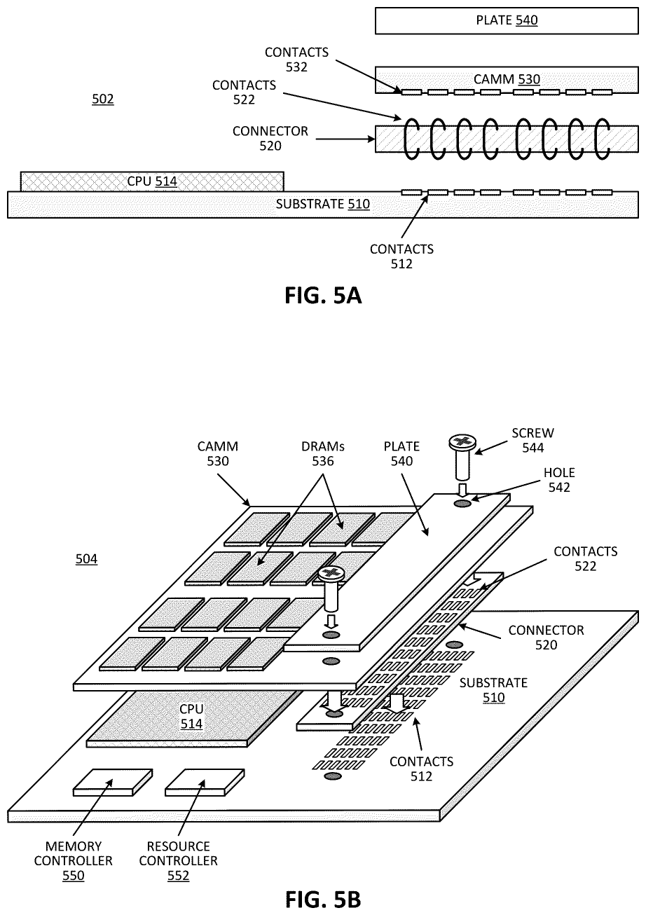

FIGS. 5A-5B are block diagrams of an example of a CAMM system in which shallow self refresh can be implemented.

Referring to FIG. 5A, system 502 includes a memory stack architecture monitored by a memory fault tracker that can perform mirroring. System 502 is a system in accordance with an example of system 100 or an example of system 200.

Substrate 510 illustrates an SOC package substrate or a motherboard or system board. Substrate 510 includes contacts 512, which represent contacts for connecting with memory. CPU 514 represents a processor or central processing unit (CPU) chip or graphics processing unit (GPU) chip to be disposed on substrate 510. CPU 514 performs the computational operations in system 502. In one example, CPU 514 includes multiple cores (not specifically shown), which can generate operations that request data to be read from and written to memory. CPU 514 can include a memory controller to manage access to the memory devices.

Compression-attached memory module (CAMM) 530 represents a module with memory devices, which are not specifically illustrated in system 502. Substrate 510 couples to CAMM 530 and its memory devices through compression mount technology (CMT) connector 520. Connector 520 includes contacts 522, which are compression-based contacts. The compression-based contacts are compressible pins or devices whose shape compresses with the application of pressure on connector 520. In one example, contacts 522 represent C-shaped pins as illustrated. In one example, contacts 522 represent another compressible pin shape, such as a spring-shape, an S-shape, or pins having other shapes that can be compressed.

CAMM 530 includes contacts 532 on a side of the CAMM board that interfaces with connector 520. Contacts 532 connect to memory devices on the CAMM board. Plate 540 represents a plate or housing that provides structure to apply pressure to compress contacts 522 of connector 520.

Referring to FIG. 5B, system 504 is a perspective view of a system in accordance with system 502. System 504 illustrates memory controller 550, which is not specifically illustrated in system 502. CAMM 530 is illustrated with memory chips or memory dies, identified as DRAMs 536 on one or both faces of the PCB of CAMM 530. In a client device implementation, DRAMs 536 can be on either face of the PCB. In a server implementation, DRAMs 536 will be only on one face of the PCB to manage power density. DRAMs 536 are coupled with conductive contacts via conductive traces in or on the PCB, which couples with contacts 532, which in turn couple with contacts 522 of connector 520.

System 504 illustrates holes 542 in plate 540 to receive fasteners, represented by screws 544. There are corresponding holes through CAMM 530, connector 520, and in substrate 510. Screws 544 can compressibly attach the CAMM 530 to substrate 510 via connector 520.

In one example, system 504 includes resource controller 552, which represents a circuit of a power management controller in accordance with any example herein. Resource controller 552 can connect with memory controller 550 via a system-level link, allowing memory controller 550 to provide memory access idleness information to the PMC, and enabling the PMC to trigger memory controller 550 to issue a low power state without clock stop, in accordance with any description herein.

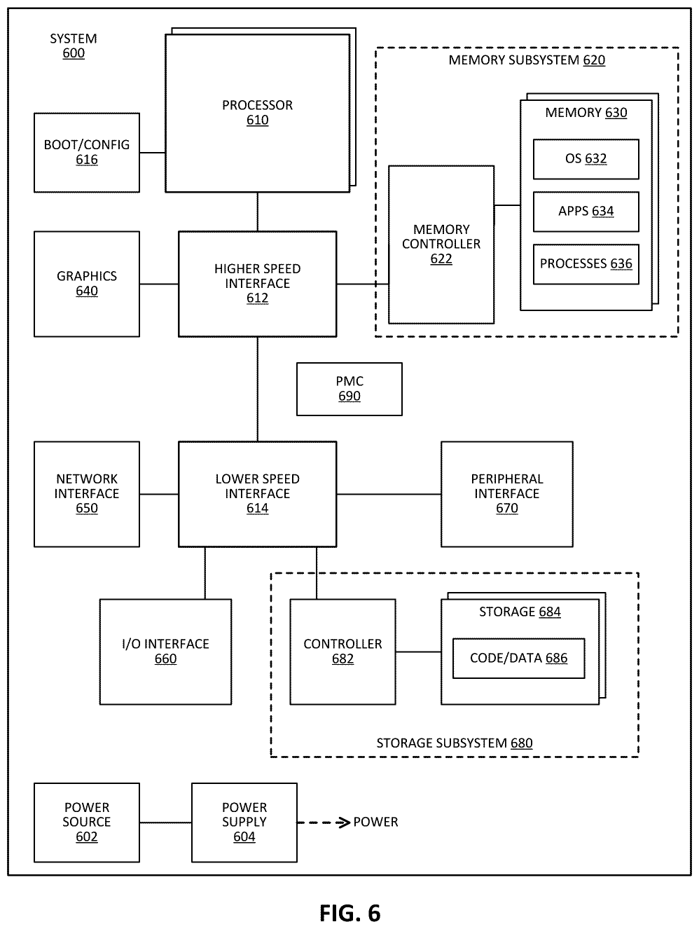

FIG. 6 is a block diagram of an example of a computing system in which shallow self refresh can be implemented. System 600 represents a computing device in accordance with any example herein, and can be a laptop computer, a desktop computer, a tablet computer, a server, a gaming or entertainment control system, embedded computing device, or other electronic device.

System 600 is an example of a system in accordance with an example of system 100 or an example of system 200. In one example, system 600 includes PMC 690, which includes a resource controller circuit in accordance with any example herein. PMC 690 can be located on an SOC with processor 610. PMC 690 can connect with memory controller 622 via a system-level link, allowing memory controller 622 to provide memory access idleness information to PMC 690, and enabling PMC 690 to trigger memory controller 622 to issue a low power state without clock stop, in accordance with any description herein.

System 600 includes processor 610 can include any type of microprocessor, central processing unit (CPU), graphics processing unit (GPU), processing core, or other processing hardware, or a combination, to provide processing or execution of instructions for system 600. Processor 610 can be a host processor device. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or a combination of such devices.

System 600 includes boot/config 616, which represents storage to store boot code (e.g., basic input/output system (BIOS)), configuration settings, security hardware (e.g., trusted platform module (TPM)), or other system level hardware that operates outside of a host OS. Boot/config 616 can include a nonvolatile storage device, such as read-only memory (ROM), flash memory, or other memory devices.

In one example, system 600 includes interface 612 coupled to processor 610, which can represent a higher speed interface or a high throughput interface for system components that need higher bandwidth connections, such as memory subsystem 620 or graphics interface components 640. Interface 612 represents an interface circuit, which can be a standalone component or integrated onto a processor die. Interface 612 can be integrated as a circuit onto the processor die or integrated as a component on a system on a chip. Where present, graphics interface 640 interfaces to graphics components for providing a visual display to a user of system 600. Graphics interface 640 can be a standalone component or integrated onto the processor die or system on a chip. In one example, graphics interface 640 can drive a high definition (HD) display or ultra high definition (UHD) display that provides an output to a user. In one example, the display can include a touchscreen display. In one example, graphics interface 640 generates a display based on data stored in memory 630 or based on operations executed by processor 610 or both.

Memory subsystem 620 represents the main memory of system 600, and provides storage for code to be executed by processor 610, or data values to be used in executing a routine. Memory subsystem 620 can include one or more varieties of random-access memory (RAM) such as DRAM, 3DXP (three-dimensional crosspoint), or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610, such as integrated onto the processor die or a system on a chip.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or other bus, or a combination.

In one example, system 600 includes interface 614, which can be coupled to interface 612. Interface 614 can be a lower speed interface than interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can exchange data with a remote device, which can include sending data stored in memory or receiving data to be stored in memory.

In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, NAND, 3DXP, or optical based disks, or a combination. Storage 684 holds code or instructions and data 686 in a persistent state (i.e., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (i.e., the value or state of the data is indeterminate if power is interrupted to system 600). In one example, storage subsystem 680 includes controller 682 to interface with storage 684. In one example controller 682 is a physical part of interface 614 or processor 610, or can include circuits or logic in both processor 610 and interface 614.

Power source 602 provides power to the components of system 600. More specifically, power source 602 typically interfaces to one or multiple power supplies 604 in system 600 to provide power to the components of system 600. In one example, power supply 604 includes an AC to DC (alternating current to direct current) adapter to plug into a wall outlet. Such AC power can be renewable energy (e.g., solar power) power source 602. In one example, power source 602 includes a DC power source, such as an external AC to DC converter. In one example, power source 602 or power supply 604 includes wireless charging hardware to charge via proximity to a charging field. In one example, power source 602 can include an internal battery or fuel cell source.

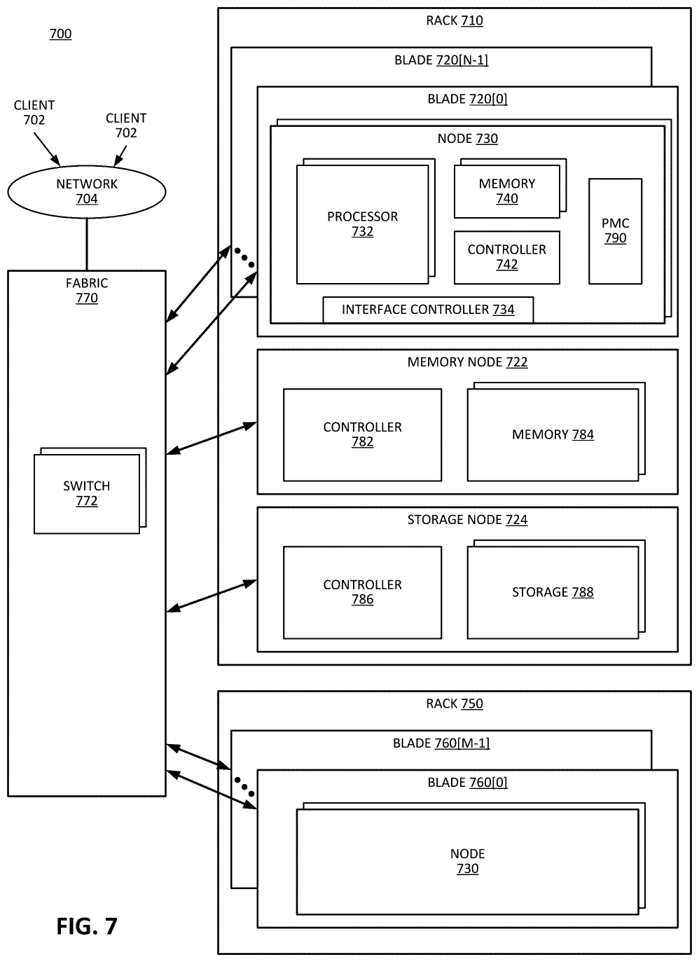

FIG. 7 is a block diagram of an example of a multi-node network in which shallow self refresh can be implemented. In one example, system 700 represents a data center. In one example, system 700 represents a server farm. In one example, system 700 represents a data cloud or a processing cloud.

Nodes 730 of system 700 represent a system in accordance with an example of system 100 or an example of system 200. In one example, node 730 includes PMC 790, which includes a resource controller circuit in accordance with any example herein. PMC 790 can connect with controller 742 via a system-level link, allowing controller 742 to provide memory access idleness information to PMC 790, and enabling PMC 790 to trigger controller 742 to issue a low power state without clock stop, in accordance with any description herein.

One or more clients 702 make requests over network 704 to system 700. Network 704 represents one or more local networks, or wide area networks, or a combination. Clients 702 can be human or machine clients, which generate requests for the execution of operations by system 700. System 700 executes applications or data computation tasks requested by clients 702.

In one example, system 700 includes one or more racks, which represent structural and interconnect resources to house and interconnect multiple computation nodes. In one example, rack 710 includes multiple nodes 730. In one example, rack 710 hosts multiple blade components, blade 720[0], . . . , blade 720[N−1], collectively blades 720. Hosting refers to providing power, structural or mechanical support, and interconnection. Blades 720 can refer to computing resources on printed circuit boards (PCBs), where a PCB houses the hardware components for one or more nodes 730. In one example, blades 720 do not include a chassis or housing or other “box” other than that provided by rack 710. In one example, blades 720 include housing with exposed connector to connect into rack 710. In one example, system 700 does not include rack 710, and each blade 720 includes a chassis or housing that can stack or otherwise reside in close proximity to other blades and allow interconnection of nodes 730.

System 700 includes fabric 770, which represents one or more interconnectors for nodes 730. In one example, fabric 770 includes multiple switches 772 or routers or other hardware to route signals among nodes 730. Additionally, fabric 770 can couple system 700 to network 704 for access by clients 702. In addition to routing equipment, fabric 770 can be considered to include the cables or ports or other hardware equipment to couple nodes 730 together. In one example, fabric 770 has one or more associated protocols to manage the routing of signals through system 700. In one example, the protocol or protocols is at least partly dependent on the hardware equipment used in system 700.

As illustrated, rack 710 includes N blades 720. In one example, in addition to rack 710, system 700 includes rack 750. As illustrated, rack 750 includes M blade components, blade 760[0], . . . , blade 760[M−1], collectively blades 760. M is not necessarily the same as N; thus, it will be understood that various different hardware equipment components could be used, and coupled together into system 700 over fabric 770. Blades 760 can be the same or similar to blades 720. Nodes 730 can be any type of node and are not necessarily all the same type of node. System 700 is not limited to being homogenous, nor is it limited to not being homogenous.

The nodes in system 700 can include compute nodes, memory nodes, storage nodes, accelerator nodes, or other nodes. Rack 710 is represented with memory node 722 and storage node 724, which represent shared system memory resources, and shared persistent storage, respectively. One or more nodes of rack 750 can be a memory node or a storage node.

Nodes 730 represent examples of compute nodes. For simplicity, only the compute node in blade 720[0] is illustrated in detail. However, other nodes in system 700 can be the same or similar. At least some nodes 730 are computation nodes, with processor (proc) 732 and memory 740. A computation node refers to a node with processing resources (e.g., one or more processors) that executes an operating system and can receive and process one or more tasks. In one example, at least some nodes 730 are server nodes with a server as processing resources represented by processor 732 and memory 740.

Memory node 722 represents an example of a memory node, with system memory external to the compute nodes. Memory nodes can include controller 782, which represents a processor on the node to manage access to the memory. The memory nodes include memory 784 as memory resources to be shared among multiple compute nodes.

Storage node 724 represents an example of a storage server, which refers to a node with more storage resources than a computation node, and rather than having processors for the execution of tasks, a storage server includes processing resources to manage access to the storage nodes within the storage server. Storage nodes can include controller 786 to manage access to the storage 788 of the storage node.

In one example, node 730 includes interface controller 734, which represents logic to control access by node 730 to fabric 770. The logic can include hardware resources to interconnect to the physical interconnection hardware. The logic can include software or firmware logic to manage the interconnection. In one example, interface controller 734 is or includes a host fabric interface, which can be a fabric interface in accordance with any example described herein. The interface controllers for memory node 722 and storage node 724 are not explicitly shown.

Processor 732 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory 740 can be or include memory devices represented by memory 740 and a memory controller represented by controller 742.

In general with respect to the descriptions herein, in one aspect, a system on a chip (SOC) platform includes: a physical interface (PHY) to a memory device; and a resource controller circuit to determine that the memory device has been idle for a threshold length of time, and in response to the determination, to trigger a memory controller for the memory device to issue a command for self-refresh without clock stop.

In one example of the SOC platform, the resource controller circuit to determine the memory device has been idle for the threshold length of time comprises the resource controller circuit to monitor indications from the memory controller about memory access traffic. In accordance with any preceding example of the SOC platform, in one example, in response to an indication from the memory controller of memory access traffic to the memory device, the resource controller circuit is to reset an inactivity timer that monitors a length of time the memory device has been idle. In accordance with any preceding example of the SOC platform, in one example, after determining that the memory device has been idle for the threshold length of time, the resource controller circuit is to trigger the memory controller to issue the command for self-refresh without clock stop based on system-level power states. In accordance with any preceding example of the SOC platform, in one example, the resource controller circuit comprises a circuit of a power management controller (PMC) for the SOC platform. In accordance with any preceding example of the SOC platform, in one example, the resource controller circuit is to make the determination that the memory device has been idle for the threshold length of time in cooperation with firmware of the PMC. In accordance with any preceding example of the SOC platform, in one example, the threshold length of time comprises a length of time programmable by a power management controller (PMC) firmware. In accordance with any preceding example of the SOC platform, in one example, the memory controller and the resource controller circuit are to communicate through an advanced microcontroller bus architecture (AMBA) interface.

In general with respect to the descriptions herein, in one aspect, a computer system includes: a memory controller to couple to a memory device, the memory controller to generate indications about access requests for the memory device; and a power management controller (PMC) coupled to the memory controller, the PMC having a hardware portion and a firmware portion, the hardware portion including a resource controller circuit to determine that the memory device has been idle for a threshold length of time, and in response to the determination, to trigger the memory controller to issue a command to place the memory device in shallow self-refresh.

In one example of the computer system, the resource controller circuit is to manage an idle timer based on the indications from the memory controller about memory access requests. In accordance with any preceding example of the computer system, in one example, in response to an indication from the memory controller of a memory access request, the resource controller circuit is to reset the idle timer. In accordance with any preceding example of the computer system, in one example, after determining that the memory device has been idle for the threshold length of time, the resource controller circuit is to trigger the memory controller to issue the command based on system-level power states managed by the firmware portion of the PMC. In accordance with any preceding example of the computer system, in one example, the resource controller circuit is to make the determination that the memory device has been idle for the threshold length of time in cooperation with the firmware portion. In accordance with any preceding example of the computer system, in one example, the threshold length of time comprises a length of time programmable by the firmware portion of the PMC. In accordance with any preceding example of the computer system, in one example, the memory controller and the resource controller circuit are to communicate through an advanced microcontroller bus architecture (AMBA) interface. In accordance with any preceding example of the computer system, in one example, the computer system includes a host processor device coupled to the memory controller. In accordance with any preceding example of the computer system, in one example, the computer system includes a display communicatively coupled to a host processor coupled to the memory controller. In accordance with any preceding example of the computer system, in one example, the computer system includes a network interface communicatively coupled to a host processor coupled to the memory controller. In accordance with any preceding example of the computer system, in one example, the computer system includes a battery to power the computer system.

In general with respect to the descriptions herein, in one aspect, a method for managing memory includes: determining with a resource controller circuit of a system on a chip (SOC) that a memory device coupled to a memory controller of the SOC has been idle for a threshold length of time; and in response to the determination, triggering the memory controller to issue a command for self-refresh without clock stop.

In one example of the method, the method further includes: receiving an indication from the memory controller of memory access traffic to the memory device; and resetting an inactivity timer that monitors a length of time the memory device has been idle. In accordance with any preceding example of the method, in one example, the threshold length of time comprises a length of time programmable by a power management controller (PMC) firmware. In accordance with any preceding example of the method, in one example, the memory controller and the resource controller circuit communicate through an advanced microcontroller bus architecture (AMBA) interface. In accordance with any preceding example of the method, in one example, the resource controller circuit comprises a circuit of a power management controller (PMC) for the SOC. In accordance with any preceding example of the method, in one example, resetting the inactivity timer comprises determining in conjunction with firmware of the PMC that the memory device has been idle for the threshold length of time.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. A system on a chip (SOC) platform, comprising:
a physical interface (PHY) to a memory device; and
a resource controller circuit to determine that the memory device has been idle for a threshold length of time, and in response to the determination, to trigger a memory controller for the memory device to issue a command for self-refresh without clock stop.

2. The SOC platform of claim 1, wherein the resource controller circuit to determine the memory device has been idle for the threshold length of time comprises the resource controller circuit to monitor indications from the memory controller about memory access traffic.

3. The SOC platform of claim 1, wherein in response to an indication from the memory controller of memory access traffic to the memory device, the resource controller circuit is to reset an inactivity timer that monitors a length of time the memory device has been idle.

4. The SOC platform of claim 1, wherein after determining that the memory device has been idle for the threshold length of time, the resource controller circuit is to trigger the memory controller to issue the command for self-refresh without clock stop based on system-level power states.

5. The SOC platform of claim 1, wherein the resource controller circuit comprises a circuit of a power management controller (PMC) for the SOC platform.

6. The SOC platform of claim 5, wherein the resource controller circuit is to make the determination that the memory device has been idle for the threshold length of time in cooperation with firmware of the PMC.

7. The SOC platform of claim 1, wherein the threshold length of time comprises a length of time programmable by a power management controller (PMC) firmware.

8. The SOC platform of claim 1, wherein the memory controller and the resource controller circuit are to communicate through an advanced microcontroller bus architecture (AMBA) interface.

9. A computer system comprising:
a memory controller to couple to a memory device, the memory controller to generate indications about access requests for the memory device; and
a power management controller (PMC) coupled to the memory controller, the PMC having a hardware portion and a firmware portion, the hardware portion including a resource controller circuit to determine that the memory device has been idle for a threshold length of time, and in response to the determination, to trigger the memory controller to issue a command to place the memory device in shallow self-refresh.

10. The computer system of claim 9, wherein the resource controller circuit is to manage an idle timer based on the indications from the memory controller about memory access requests.

11. The computer system of claim 10, wherein in response to an indication from the memory controller of a memory access request, the resource controller circuit is to reset the idle timer.

12. The computer system of claim 9, wherein after determining that the memory device has been idle for the threshold length of time, the resource controller circuit is to trigger the memory controller to issue the command based on system-level power states managed by the firmware portion of the PMC.

13. The computer system of claim 9, wherein the resource controller circuit is to make the determination that the memory device has been idle for the threshold length of time in cooperation with the firmware portion.

14. The computer system of claim 9, wherein the threshold length of time comprises a length of time programmable by the firmware portion of the PMC.

15. The computer system of claim 9, wherein the memory controller and the resource controller circuit are to communicate through an advanced microcontroller bus architecture (AMBA) interface.

16. The computer system of claim 9, further comprising one or more of:
a host processor device coupled to the memory controller;
a display communicatively coupled to a host processor coupled to the memory controller;
a network interface communicatively coupled to a host processor coupled to the memory controller; or
a battery to power the computer system.

17. A method for managing memory, comprising:
determining with a resource controller circuit of a system on a chip (SOC) that a memory device coupled to a memory controller of the SOC has been idle for a threshold length of time; and
in response to the determination, triggering the memory controller to issue a command for self-refresh without clock stop.

18. The method of claim 17, further comprising:
receiving an indication from the memory controller of memory access traffic to the memory device; and
resetting an inactivity timer that monitors a length of time the memory device has been idle.

19. The method of claim 18, wherein the threshold length of time comprises a length of time programmable by a power management controller (PMC) firmware, wherein the memory controller and the resource controller circuit communicate through an advanced microcontroller bus architecture (AMBA) interface.

20. The method of claim 18, wherein the resource controller circuit comprises a circuit of a power management controller (PMC) for the SOC, and wherein resetting the inactivity timer comprises determining in conjunction with firmware of the PMC that the memory device has been idle for the threshold length of time.
